(19) United States
(12) Patent Application Publication
(10) Pub. No.: US 2006/0255664 A1
(43) Pub. Date: Nov. 16, 2006

(54) Drive unit generating an oscillatory motion for small electrical appliances

(76) Inventors: Bernhard Kraus, Braunfels (DE); Hansjorg Reick, Steinbach (DE); Uwe Schober, Glashutten (DE)

Correspondence Address: FISH & RICHARDSON PC, P.O. BOX 1022, MINNEAPOLIS, MN, 55440-1022, US

(21) Appl. No.: 11/412,735

(22) Filed: Apr. 27, 2006

Related U.S. Application Data
(63) Continuation of application No. PCT/EP04/11467, filed on Oct. 13, 2004.

(30) Foreign Application Priority Data
Oct. 29, 2003 (DE) 103 50 447.8

(51) Int. Cl. H02K 33/00; H01F 7/14; H02K 35/00

(52) U.S. Cl. 310/36; 335/279; 335/272

(57) ABSTRACT

A drive unit for generating an oscillatory motion for small electric appliance, for example a toothbrush or razor. The drive unit includes a stator having at least one coil and a first and a second magnet arrangement each having at least one permanent magnet. The drive unit further includes a rotor which is not symmetrical about the axis and has a first and a second radial projection, each extending only over a partial area of the circumference of the rotor and made of a magnetizable material. By positioning the magnet arrangements relative to the radial projections of the rotor, relative assignments between the magnet arrangements and the radial projections are formed in pairs, such that the magnetic interaction between the magnet arrangement and the radial projection of one pair is invariably greater than the magnetic interaction between the magnet arrangement and the radial projection of two different pairs.

### CROSS REFERENCE TO RELATED APPLICATIONS

This application is a continuation of PCT application serial number PCT/EP2004/011467, filed Oct. 13, 2004, which claims priority under 35 U.S.C. §119(a) from German application serial number DE 103 50 447.8, filed Oct. 29, 2003, the entire contents of both of which are hereby incorporated by reference.

### TECHNICAL FIELD

This application relates to a drive unit for generating an oscillatory motion for small electrical appliances, such as electric shavers and toothbrushes.

### BACKGROUND

Electrical drive units for generating an oscillatory motion are used, for example, in electric toothbrushes or in electric shaving appliances. U.S. Pat. No. 5,263,218 discloses, inter alia, an electric toothbrush having a pivotal lever arm, on which a brush is arranged, the lever arm being set in a vibrating motion by means of a stationary electromagnet and a stationary permanent magnet. For this purpose, the lever arm has, adjacent to the electromagnet, an area made of a ferromagnetic material which partially encloses the permanent magnet. The ferromagnetic material serves to couple the magnetic flux generated by the permanent magnet to the electromagnet and to thereby drive the lever arm.

U.S. Pat. No. 5,613,259 discloses an oscillating tool, in particular an electric toothbrush. This tool includes a mechanical oscillator which is acted upon by an electric motor. The electric motor has a stator with a coil and a rotor which is equipped with permanent magnets. The electric motor is controlled as a function of the resonant frequency of the mechanical oscillator, which is detected by means of a sensor, in such a way that the mechanical oscillator is maintained at resonance under the variety of toads imposed. The mechanical oscillator is a spring-mass embodiment which may utilize a coil spring or a torsion bar.

Patent No. EP 1 329 203 A1 discloses an electric toothbrush having a linearly oscillating drive shaft for a push-on toothbrush and a vibration damper which is connected to the drive shaft by means of a spring. Arranged on the drive shaft is an armature, which is made of a magnetizable material and essentially has a cylindrical form. The electric toothbrush further has a stationary coil and stationary permanent magnets in order to set the shaft in an oscillatory motion in the axial direction.

Patent No. DE 30 25 708 A1 discloses a small-scale alternating-current motor with an oscillating rotor, in particular for the purpose of driving, in an oscillating manner, a toothbrush mounted on the rotor shaft. The small-scale motor has a stator and an oscillating rotor. The stator is comprised of a housing made of a magnetizable material, a coil and a pair of permanent magnets. The rotor has an armature part which is secured to the rotor shaft, and two pole pieces which are arranged diametrically opposite to each other on said armature part. The coil has its axis orientated at right angles to the rotor shaft and essentially at right angles to the magnetic stator field between the permanent magnets. The coil lies within the stator housing essentially between the permanent magnets and encloses the armature part.

### SUMMARY

In one aspect of the invention, a drive unit for generating an oscillatory motion for an electrical small-scale unit includes a stator having at least one coil, and a first and a second magnet arrangement each having at least one permanent magnet. The drive unit further includes a rotor which is not symmetrical about the axis, and has a first and a second radial projection, each extending only over a partial area of the circumference of the rotor and made of a magnetizable material. By positioning the magnet arrangements relative to the radial projections of the rotor, relative assignments between the magnet arrangements and the radial projections are formed in pairs, such that the magnetic interaction between the magnet arrangement and the radial projection of one pair is invariably greater than the magnetic interaction between the magnet arrangement and the radial projection of two different pairs.

Certain implementations may have one or more of the following advantages. The rotor has a low mass and a low moment of inertia, and as a consequence, unwanted vibrations are generated only to a small extent. Moreover, a high torque can be accomplished with a small diameter of the drive unit ,and the drive unit has a high degree of efficiency. Additionally, due to the closed magnetic circuit, only low magnetic stray fields occur in the drive unit.

According to one preferred embodiment of the drive unit, each radial projection has one radial end, and each magnet arrangement is arranged in the vicinity of the radial end of a corresponding one of the radial projections. In this arrangement, the radial projections each preferably have a uniform extension in circumferential direction in at least one area adjoining the radial ends. In order to enable optimum magnetization of the radial projections with the aid of the coil, the radial projections may be arranged diametrically opposed to each other on the rotor. In the rest position, the radial projections are preferably orientated parallel to the axis of the coil.

In some configurations the magnet arrangements each include at least two permanent magnets that are spaced apart from each other in circumferential direction. In particular, the two permanent magnets are arranged side-by-side with anti-parallel orientation. It is also possible that the magnet arrangements each include one permanent magnet having at least two areas which are magnetized anti-parallel to each other and a magnetization gap between the two magnetized areas. In order to enable an optimum back-iron, the permanent magnets of the magnet arrangements may be arranged on carrier plates made of a magnetizable material, with one carrier plate provided for each magnet arrangement.

The rotor may be coupled to the stator by means of a restoring interaction, thereby enabling an oscillatory system to be provided. In this way, a large amplitude of oscillatory motion can be generated by means of a comparatively low drive energy. It is particularly advantageous if the restoring interaction is configured in such a way that, under load, the resonant frequency of the oscillatory system shifts towards an excitation frequency exciting the oscillatory system. As a consequence of this, a collapse of the amplitude of the oscillatory motion can be countered without change to the excitation frequency. The excitation frequency is preferably selected greater than the resonant frequency. The restoring interaction may have a characteristic adapted to be influenced by the formation of the radial projections and/or by the magnet arrangements, so that, in order to achieve the desired properties, only these components need to be adapted or adjusted. In this way, it is also possible to compensate for tolerances which have an effect on the magnetic interaction between the magnet arrangements and the radial projections. The restoring interaction preferably has a non-linear characteristic. In this way it is possible to obtain an oscillatory response of the drive unit, optimized for the particular application.

In one embodiment of the drive unit, the rotor is coupled to the stator by means of a torsion bar, with at least partial areas of the torsion bar being positioned within a hollow shaft of the rotor. This embodiment has the advantage of enabling the torsion bar to be manufactured with very high precision in terms of its elastic properties, so that there is therefore not a significant variation of the resonant frequencies of drive units during production. Furthermore, if the torsion bar is received in the hollow shaft, then hardly any additional space is required. Alternatively, the rotor may be coupled to the stator by means of a helical spring or a spiral spring.

In an advantageous aspect of the drive unit, provision can be made for a housing having two housing parts, which overlap in the area of the magnet arrangements in a circumferential direction. This facilitates the assembly of the drive unit, enabling almost any form of housing to be used. In addition, the back-iron is improved through the housing, such that in many instances the carrier plates for the permanent magnets can be dispensed with.

Other aspects relate to a small electrical appliance equipped with the drive unit. The as appliance may be in the form of an electric toothbrush, or an electrical shaving appliance, as examples.

Other aspects, features, and advantages will be apparent from the following detailed description, the drawings, and the claims.

### DESCRIPTION OF DRAWINGS

FIG. 1 is a very schematic cross-sectional view of an embodiment of a drive unit;

FIG. 2 is a diagram showing various curve shapes indicative of the restoring torque acting on the rotor as a function of the displacement of the rotor from its rest position;

FIG. 3 is a diagram showing the oscillatory response of the drive unit in the neighborhood of the resonant frequency under various loads and for different configurations of the drive unit;

FIG. 4 is a view of a further embodiment of the drive unit in a representation corresponding to FIG. 1;

FIG. 5 is a view of still another embodiment of the drive unit in a representation corresponding to FIG. 1;

FIG. 6 is a view of an embodiment, once again modified, of the drive unit in a representation corresponding to FIG. 1; and

FIG. 7 is a perspective view of a concrete design for an embodiment of the drive unit.

### DETAILED DESCRIPTION

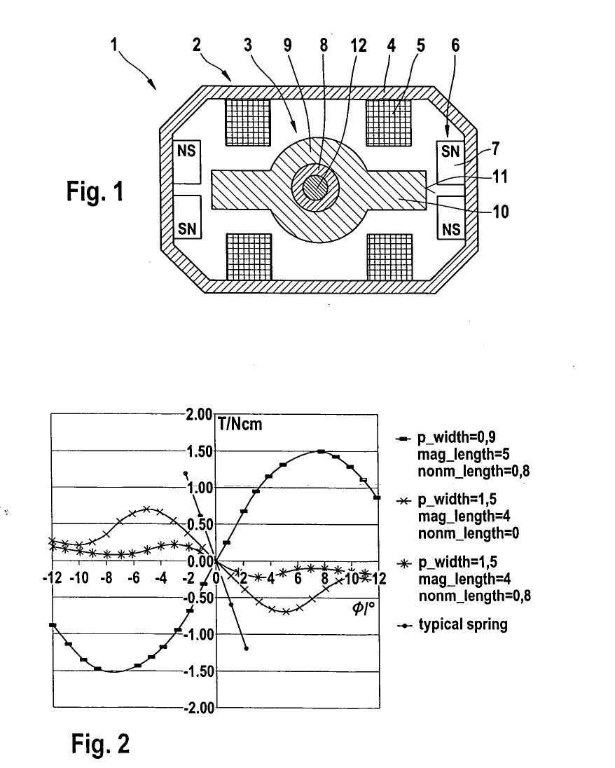

Referring to FIG. 1, the drive unit 1 includes a stationary stator 2, and a rotor 3 mounted for rotation relative to the stator 2 about the longitudinal axis of the drive unit 1. The stator 2 has a housing 4 made of a magnetizable material, two coils 5 connected for example in series, and two magnet arrangements 6 which each have two permanent magnets 7. The two coils 5 are arranged parallel to each other, with the axes of the coils 5 coinciding with each other, and extending horizontally in the representation of FIG. 1. The magnet arrangements 6 are arranged facing each other on opposite sides of the housing 4, with the individual permanent magnets 7 of the magnet arrangements 6 being each positioned side-by-side symmetrically to the axis of the coils 5 with anti-parallel polarity. In this arrangement, a small space is maintained between the two permanent magnets 7 of each magnet arrangement 6, it being possible to vary the space for example for adjustment or calibration purposes. The rotor 3 is arranged coaxially within the stator 2 and has a shaft 8 on which an armature 9 made of a magnetizable material is arranged. For example, the armature 9 can be composed of two sheets of soft ferrous material arranged axially side-by-side. One radial projection 10 is formed in each of two circumferential areas of the armature 9, so that the armature 9 extends further radially outward there, than in the circumferential areas in between, and is therefore not symmetrical about the axis. In the rest position of the drive unit 1 shown in FIG. 1, the radial projections 10 extend in opposite directions parallel to the axis of the coils 5, reaching with their radial ends 11 into the close vicinity of the permanent magnets 7. In this arrangement, the axes of the coils 5 run centrally through the radial projections 10. In the embodiment shown, the shaft 8 is hollow and has in its interior a concentrically arranged torsion bar 12 having its one end non-rotatably connected to the stator 2 and its other end non-rotatably connected to the rotor 3, thereby exerting a restoring torque on the rotor 3 which acts towards the rest position of the drive unit 1.

When a current flows through the coils 5, a magnetic field is generated in the armature 9 which is orientated parallel to the radial projections 10 of the armature 9, so that, in the area of the radial ends 11 of the radial projections 10, opposed magnetic poles are formed, resulting in a magnetic interaction with the permanent magnets 7 of the magnet arrangements 6. By virtue of the magnetic interaction a torque is exerted on the armature 9, causing the armature 9 to be displaced from its rest position, and the shaft 8 to be rotated slightly in the process. As opposed magnetic poles are formed in the area of the two radial projections 10 of the armature 9, the magnetic interaction of the two magnet arrangements 6 with the respective neighboring radial projections 10 of the armature 9 result in torques acting in the same direction, which are accordingly cumulative. In view of the large distance, the magnetic interaction occurring between the magnet arrangements 6 and the respective diametrically opposed radial projections 10 of the armature 9 is significantly lower than the above described magnetic interaction between neighboring magnet arrangements 6 and radial projections 10 of the armature 9.

Given a predetermined orientation of the magnet arrangements 6, the rotational motion of the rotor 3 caused by the magnetic interaction depends on the direction of the magnetic field generated in the armature 9, and therefore also on the direction of the current in the coils 5. As a result, it is possible to reverse the direction of rotation of the rotor 3 by reversing the current flow in the coils 5, and therefore to rotate the rotor 3 back to its rest position. The rotational motion in the direction toward the rest position is further assisted by the restoring torque generated by the torsion bar 12. Through periodic reversal of the polarity of the current flow in the coils 5 it is possible to generate an oscillatory rotational motion of the rotor 3. Considering that the torsion bar 12 and the rotor 3 form an oscillatory spring-mass system, the amplitude of the oscillatory rotational motion for a given current applied to the coils 5 is particularly large when the frequency of the current signal coincides with the resonant frequency of the spring-mass system. The resonant frequency depends on the moment of inertia of the rotor 3 and the torsion bar 12 as well as on the spring constant of the torsion bar 12. Furthermore, the resonant frequency can also be influenced by the magnet arrangements 6 and the radial projections 10 of the armature 9, as the permanent magnets 7 cause a magnetic restoring torque to be exerted on the rotor 3, the characteristics of which depend on the geometry of the magnet arrangements 6 and on the design of the radial projections 10 of the armature 9 in the vicinity of their radial ends 11. The space between neighboring permanent magnets 7 of a magnet arrangement 6 is particularly well suited for individual variation of the magnetic restoring torque. The magnetic restoring torque acts in the manner of an additional spring between the stator 2 and the rotor 3, with the influence of the magnetic restoring torque on the spring characteristic being relatively complex. For illustration, FIG. 2 shows by way of example some typical curve shapes representing the magnetic restoring torque.

FIG. 2 shows a diagram with various curve shapes indicative of the restoring torque acting on the rotor 3 as a function of the displacement of the rotor 3 from its rest position. The angle of rotation Φ, through which the rotor 3 is rotated out from its rest position, is plotted on the abscissa. The restoring torque T is plotted on the ordinate. The entered curve shapes represent different sets of parameters for the width p_width of the radial projections 10 of the armature 9 in the area of the radial ends 11, for the longitudinal extension mag_length of the permanent magnets 7 of the magnet arrangements 6, and for the distance nonm_length between neighboring permanent magnets 7 of a magnet arrangement 6. All of the curve shapes respectively represent the conditions that are present in the absence of current flow through the coils 5. By way of comparison, the diagram also shows the curve shape for a conventional spring in which the restoring torque T increases in magnitude proportionately to the angle of rotation Φ, so that on each displacement there exists a restoring torque T acting in the direction of the rest position in which the displacement is equal to zero. Consequently, the curve shape for a conventional spring is represented by a straight line.

For the restoring torque T produced by the magnetic interaction, the resulting curve shapes are entirely different to that of a conventional spring. The closest resemblance to the behavior of a conventional spring is given if the radial projections 10 of the armature 9 are relatively wide (p_width=1.5) and the magnet arrangements 6 are configured in such a way that relatively short permanent magnets 7 (mag_length=4) are arranged immediately side-by-side (norm_length=0). With these parameters, the curve has throughout its shape the same sign as the curve for the conventional spring, i.e., throughout the entire range shown there exists a restoring torque T acting in the direction towards the rest position. For the realization of the drive unit 1, a slightly modified curve shape is preferred which, given the same width of the radial projections 10 of the armature 9 (p_width=1.5) and the same length of the permanent magnets 7 (mag_length=4), results from a spaced arrangement of the permanent magnets 7 by a distance (nonm_length=0.8). This results in a flattening of the curve shape, while the respective sign is maintained. A further different curve shape is obtained by providing the radial projections 10 of the armature 9 with a relatively narrow width (p_width=0.9) and arranging relatively long permanent magnets 7 (mag_length=5) at a relative distance (nonm_length=0.8). In this case, the sign of the curve shape is reversed throughout the entire shown area in relation to the conventional spring. This means that, with such a set of parameters, there is no restoring torque T acting in the direction toward the rest position. Instead, the torque generated by the magnetic interaction causes a displacement from the rest position.

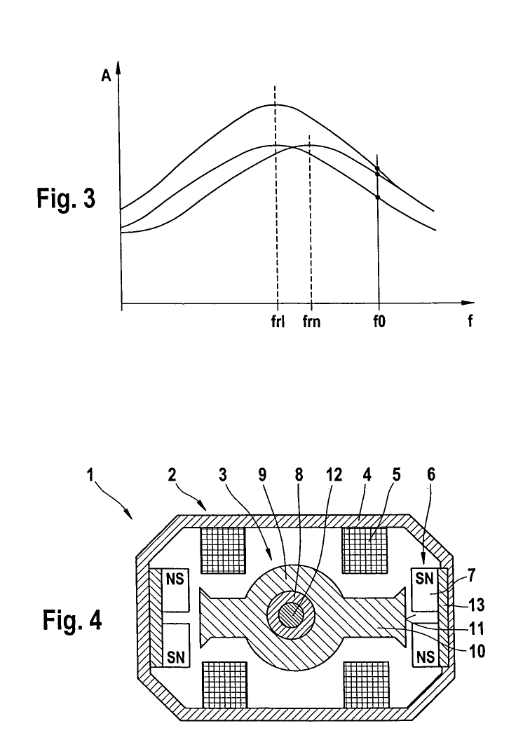

All of the curves shown in FIG. 2 for the restoring torque T based on the magnetic interaction display a pronounced non-linear shape in comparison to the conventional spring. As a result, a shift in the resonant frequency of the oscillatory system occurs when the amplitude of the oscillatory motion changes. This effect is utilized in order to minimize the load-induced reduction in the amplitude of the oscillatory motion generated by means of the drive unit 1. This will be explained in detail with reference to FIG. 3.

Referring to FIG. 3, the oscillation frequency f of the oscillatory motion is plotted on the abscissa and the amplitude A on the ordinate. All of the curves shown have in common that the amplitude A increases as the oscillation frequency f approaches the resonant frequency frl or frn of the drive unit 1 and then decreases again after the resonant frequency frl or frn is exceeded, so that the curves each have a maximum at the associated resonant frequency frl or frn. Here, frl denotes the resonant frequency of a drive unit 1 having a linear spring characteristic while frn denotes the resonant frequency of a drive unit 1 having a non-linear spring characteristic. The magnitude of the amplitude A in the area of the maximum depends on the load imposed on the drive unit 1. In this way, the top curve represents the amplitude shape for the drive unit 1 under no load. The two lower curves each show an amplitude shape with the drive unit 1 under load, so that the load-induced reduction in the amplitude A becomes apparent directly from FIG. 3. The left-hand of the two lower curves relates to a drive unit 1 having a linear spring characteristic. For a drive unit 1 configured in this way, the resonant frequency frl is maintained unchanged also under load, and only the amplitude A changes. However, in the case of a non-linear spring characteristic, the resonant frequency frn shifts as the load imposed on the drive unit 1 increases. This applies to the lower right-hand curve, in which the resonant frequency frn shifts toward higher oscillation frequencies f with increasing load. In various implementations, use can be made of a non-linear spring characteristic displaying this type of behavior. Also in this case, it is still not possible to prevent the reduction in the amplitude A under load in the area of the resonant frequency frn. However, it is possible to partially compensate for the reduction in the amplitude A. For this purpose, the drive unit 1 can be excited with a fixed frequency f0 above the resonant frequency frn. The shift in the resonant frequency frn under load then has the consequence that the excitation in the loaded state of the drive unit 1 takes place closer to the resonant frequency frn than in the unloaded state. An excitation closer to the resonant frequency frn then in turn causes a higher amplitude A at the location of the excitation frequency f0, so as to fully or partially compensate for the load-induced reduction in the amplitude A. Therefore, the reduction in the amplitude A under load is less pronounced for the non-linear spring characteristic with the excitation frequency f0 than is the case for the linear spring characteristic.

FIG. 4 shows a further embodiment in which the radial projections 10 of the armature 9 are widened in a circumferential direction near the radial ends 11. Furthermore, in this embodiment provision is made for carrier plates 13 made of a magnetizable material, on which the permanent magnets 7 of an associated magnet arrangement 6 are jointly arranged. The carrier plates 13 each serve as back-iron for the permanent magnets 7, and are particularly expedient in the case of powerful permanent magnets 7, for example permanent magnets made of NdFeB. Otherwise, the embodiment of the drive unit 1 shown in FIG. 4 corresponds in terms of design and function to the embodiment of FIG. 1.

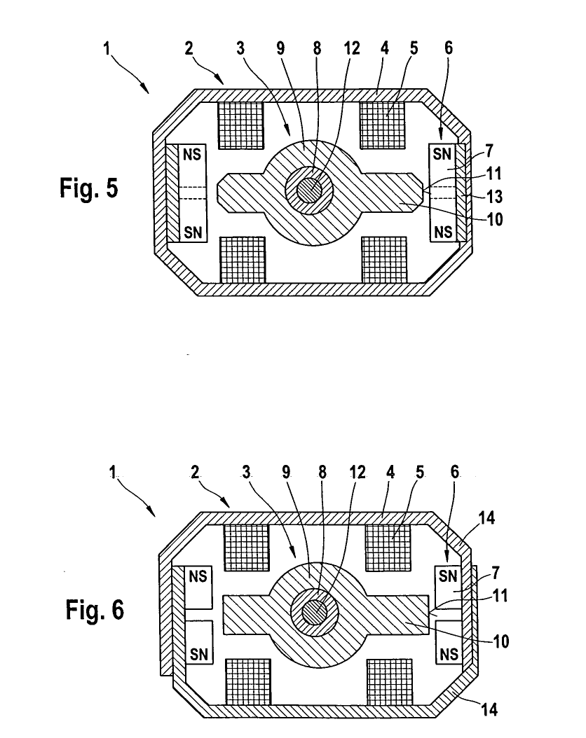

FIG. 5 shows still another embodiment of the drive unit 1 in which the radial projections 10 of the armature 9 taper near the radial ends 11, and in which each magnet arrangement 6 only has one permanent magnet 7. The permanent magnets 7 are each magnetized in such a way that two areas magnetized with anti-parallel orientation are arranged side-by-side, separated by a magnetization gap. This means that the permanent magnets 7 of the magnet arrangements 6 shown in FIGS. 1 and 4 are combined to form a single permanent magnet 7 for each magnet arrangement 6 while the magnetic orientation is maintained. Similar to the embodiment of FIG. 4, the carrier plates 13 for the permanent magnets 7 are also provided in the embodiment of FIG. 5.

FIG. 6 shows an embodiment, once again modified, of the drive unit 1 in which the housing 4 is comprised of two split shells 14 made of a magnetizable material. The split shells 14 overlap each other in the area of the magnet arrangements 6, so that an increased back-iron for the permanent magnets 7 is formed due to the doubled material thickness of the housing 4 in the overlap area. In this embodiment, the carrier plates 13 can therefore generally be omitted. Furthermore, the assembly of the drive unit 1 is made easier by virtue of the split shells 14, and almost any form of housing can be formed.

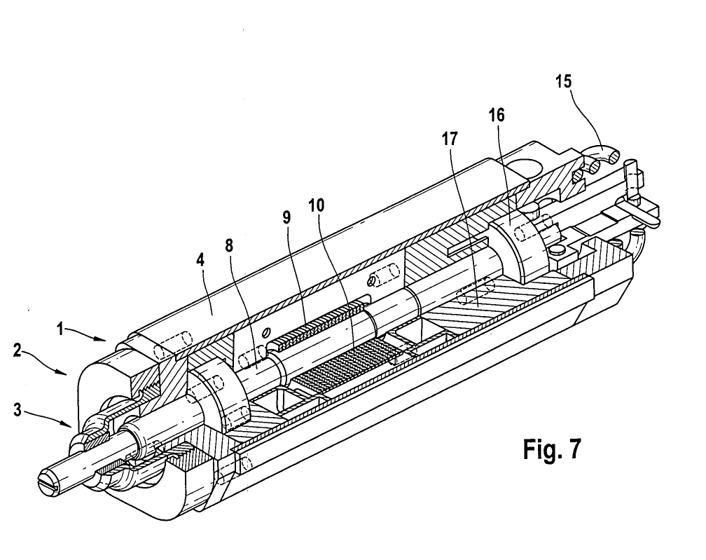

FIG. 7 is a perspective view of a concrete design for an embodiment of the drive unit 1. In this embodiment, a helical spring 15 is provided as the rotationally elastic element between the stator 2 and the rotor 3 instead of a torsion bar 12. Instead of the helical spring 15, it would also be possible for example to use a spiral spring. In the absence of a torsion bar 12, the shaft 8 is not hollow, but is formed as a solid part instead. In order to be able to mount a push-on toothbrush not shown in the Figure, the shaft 8 protrudes from the housing 4 with an axial end thereof. The shaft 8 is mounted for rotation by means of two bearings 16 which are embedded in an inner lining 17. The inner lining 17 also serves as the winding body for the coils 5, which are not drawn in FIG. 7.

In each case the drive unit 1 may be modified to the effect that shell-shaped magnet segments are substituted for the block-shaped permanent magnets 7. Furthermore, the features present in the above-described embodiments of the drive unit 1 may also be combined to form other embodiments. Other embodiments are within the scope of the following claims.

1. A drive unit for generating an oscillatory motion in a small electrical appliance, the drive unit comprising:
a stator having at least one coil defining an axis;
a first and a second magnet arrangement each having at least one permanent magnet; and
a rotor asymmetrical about an axis of rotation, and having a first and a second radial projection, each projection extending only over a partial area of a circumference of the rotor and made of a magnetizable material, wherein the magnet arrangements are positioned relative to the radial projections of the rotor to form corresponding pairings of magnet arrangements and radial projections, with magnetic interaction between any magnet arrangement and the radial projection of its pairing always exceeding any magnetic interaction between any magnet arrangement and a radial projection of a different pairing.

2. The drive unit according to claim 1, wherein each radial projection has one radial end and each magnet arrangement is arranged adjacent the radial end of only one of the radial projections.

3. The drive unit according to claim 2, wherein the radial projections each have a uniform extension in circumferential direction in at least one area adjoining the radial ends.

4. The drive unit according to claim 1, wherein the radial projections are arranged diametrically opposed to each other on the rotor.

5. The drive unit according to claim 1, wherein in the rest position the radial projections are orientated parallel to the axis of the at least one coil.

6. The drive unit according to claim 1; wherein the magnet arrangements each include at least two permanent magnets circumferentially spaced apart from each other.

7. The drive unit according to claim 6, wherein the two permanent magnets are arranged side-by-side with anti-parallel orientation.

8. The drive unit according to claim 1, wherein the magnet arrangements each include one permanent magnet having at least two areas which are magnetized anti-parallel to each other, and a magnetization gap between the two magnetized areas.

9. The drive unit according to claim 1, wherein the permanent magnets of the magnet arrangements are arranged on corresponding carrier plates made of a magnetizable material.

10. The drive unit according to claim 1, wherein the rotor is coupled to the stator by means of a restoring interaction, thereby providing an oscillatory system.

11. The drive unit according to claim 10, wherein the restoring interaction is configured in such a way that, under load, the resonant frequency of the oscillatory system shifts towards an excitation frequency exciting the oscillatory system.

12. The drive unit according to claim 11, wherein the excitation frequency is greater than the resonant frequency.

13. The drive unit according to claim 10, wherein the restoring interaction has a characteristic adapted to be influenced by the formation of the radial projections and/or by the magnet arrangements.

14. The drive unit according to claim 10, wherein the restoring interaction has a non-linear characteristic.

15. The drive unit according to claim 1, wherein the rotor is coupled to the stator by means of a torsion bar at least partially positioned within a hollow shaft of the rotor.

16. The drive unit according to claim 1, wherein the rotor is coupled to the stator by means of a helical spring or a spiral spring.

17. The drive unit according to claim 1, wherein provision is made for a housing having two housing parts which circumferentially overlap in the area of the magnet arrangements.

18. A small electrical appliance comprising a housing and the drive unit of claim 1 disposed within the housing.

19. The small electrical appliance of claim 18, comprising an electric toothbrush or shaving appliance.
